(19) United States
(12) Patent Application Publication
(10) Pub. No.: US 2026/0192727 A1
(43) Pub. Date: Jul. 9, 2026

(54) ELECTRIC ROLL-OFF REFUSE VEHICLE

(71) Applicant: Oshkosh Corporation, Oshkosh, WI (US)

(72) Inventors: Jeff Verhagen, Oshkosh, WI (US); Aaron Fisher, Oshkosh, WI (US); Greg Steffens, Oshkosh, WI (US)

(21) Appl. No.: 19/439,209

(22) Filed: Jan. 2, 2026

Related U.S. Application Data
(60) Provisional application No. 63/741,640, filed on Jan. 3, 2025.
(60) Provisional application No. 63/741,633, filed on Jan. 3, 2025.

(51) Int. Cl. B60P 1/64; B60P 7/04

(52) U.S. Cl. CPC B60P 1/6427; B60P 7/04

(57) ABSTRACT

An electric roll-off vehicle according to an embodiment of the present application includes a chassis extending a longitudinal length of the electric roll-off vehicle, a cab coupled to a front end of the chassis, an electric energy storage device coupled to the chassis, and an electric drive motor coupled to the chassis and electrically connected to the electric energy storage device for driving the electric roll-off vehicle. The electric roll-off vehicle further includes a roll-off body assembly coupled to the chassis and positioned behind the cab. The roll-off body assembly includes a roll-off body extending at least partially along the longitudinal length of the electric roll-off vehicle, a body actuator configured to move the roll-off body relative to the chassis, with the body actuator powered by the electric energy storage device, and a container lift assembly configured to pull an object onto the roll-off body.

### CROSS-REFERENCE TO RELATED APPLICATIONS

This application (a) claims the benefit of and priority to (i) U.S. Provisional Patent Application No. 63/741,633, filed Jan. 3, 2025, and (ii) U.S. Provisional Patent Application No. 63/741,640, filed Jan. 3, 2025, and (b) is related to (i) U.S. patent application Ser. No. 19/439,000 (Attorney Docket No. 061300-7304), filed Jan. 2, 2026. The entire contents of each of these applications is hereby incorporated by reference herein.

### BACKGROUND

The present disclosure relates generally to the field of refuse vehicles and, in particular, electrically powered refuse vehicles.

### SUMMARY

One embodiment relates to an electric roll-off vehicle including a chassis extending a longitudinal length of the electric roll-off vehicle, a cab coupled to a front end of the chassis, an electric energy storage device coupled to the chassis, and an electric drive motor coupled to the chassis and electrically connected to the electric energy storage device for driving the electric roll-off vehicle. The electric roll-off vehicle further includes a roll-off body assembly coupled to the chassis and positioned behind the cab. The roll-off body assembly includes a roll-off body extending at least partially along the longitudinal length of the electric roll-off vehicle, a body actuator configured to move the roll-off body relative to the chassis. The body actuator is powered by the electric energy storage device. The roll-off body assembly further includes a container lift assembly configured to pull an object onto the roll-off body.

In some embodiments, the cab includes a front portion configured as an operator portion and a rear portion configured as a storage portion. The electric roll-off vehicle further includes a cowl assembly including a front shroud coupled to and positioned above the front portion of the cab, and a rear shroud coupled to and positioned above a rear portion of the cab. In some embodiments, the rear portion of the cab includes a frame member extending upwards from a roof of the rear portion, with the frame member configured to couple to the rear shroud of the cowl assembly.

In some embodiments, the electric roll-off vehicle further includes a tarp cover assembly coupled to the chassis at a front end of the roll-off body assembly. In some embodiments, the tarp cover assembly includes a tarp partially positioned within a tarp cover body, a support column connected to the tarp cover body and to the chassis, and a tarp cover actuator coupled to the chassis and configured to extend the tarp over the object positioned on the roll-off body. In some embodiments, the electric roll-off vehicle further includes a cowl assembly positioned at least partially above the cab, where at least part of the cowl assembly is coupled to the tarp cover assembly.

In some embodiments, the cab includes a front portion configured as an operator portion and a rear portion configured as a storage portion. The electric roll-off vehicle further includes a cowl assembly at least partially coupled to the tarp cover assembly. In some embodiments, the cowl assembly includes a front shroud coupled to and positioned above the front portion of the cab, and a rear shroud positioned above the rear portion of the cab. The rear shroud is coupled to the tarp cover assembly. In some embodiments, the rear shroud is coupled to the support column of the tarp cover assembly.

Another embodiment relates to an electric roll-off vehicle including a chassis extending a longitudinal length of the electric roll-off vehicle, a cab coupled to a front end of the chassis, an electric energy storage device coupled to the chassis, an electric drive motor coupled to the chassis and electrically connected to the electric energy storage device for driving the electric roll-off vehicle, and a roll-off body assembly coupled to the chassis and positioned behind the cab. The roll-off body assembly includes a roll-off body extending at least partially along the longitudinal length of the electric roll-off vehicle, and a body actuator configured to move a front end of the roll-off body. The electric roll-off vehicle further includes a container lift assembly including a cable and a lift motor, where the container lift assembly is configured to pull an object onto the roll-off body, a tarp cover assembly coupled to the chassis at a front end of the roll-off body assembly, and a cowl assembly. The cowl assembly includes a front shroud coupled to and positioned above the cab, and a rear shroud coupled to the tarp cover assembly and defining a storage compartment below the rear shroud and between the cab and the roll-off body assembly.

In some embodiments, the tarp cover assembly includes a tarp partially positioned within a tarp cover body, a support column connected to the tarp cover body and to the chassis, and a tarp cover actuator coupled to the chassis and configured to extend the tarp over the object positioned on the roll-off body. In some embodiments, the rear shroud is coupled to the support column of the tarp cover assembly.

In some embodiments, the electric energy storage device powers the electric drive motor to drive the electric roll-off vehicle, the body actuator to raise or lower the roll-off body, and the tarp cover actuator to extends or retract the tarp over the object.

Another embodiment relates to a method of assembling an electric roll-off vehicle. Thee method includes coupling one or more energy storage devices to a chassis of the electric roll-off vehicle. The electric roll-off vehicle includes a cab coupled to the chassis at a front end thereof, and an electric drive motor coupled to the energy storage devices. The electric drive motor is configured to drive the electric roll-off vehicle, where the one or more energy storage devices are positioned rearward of the cab of the electric roll-off vehicle. The method further includes coupling a roll-off body to the chassis rearward of the cab, with the roll-off body pivotable relative to the chassis to load or unload an object onto the roll-off body. The method further includes coupling a body actuator to the roll-off body and the chassis so that the body actuator is configured to raise or lower the roll-off body to load or unload the object onto the roll-off body and so that the body actuator is powered by the one or more energy storage devices.

In some embodiments, the method further includes coupling a cowl assembly to the cab of the electric roll-off vehicle, where the cab includes a front portion configured as an operator portion and a rear portion configured as a storage portion. In some embodiments, coupling the cowl assembly to the cab of the electric roll-off vehicle includes coupling a front shroud of the cowl assembly to the front portion of the cab, where the front shroud portion is position above the front portion, and coupling a rear shroud of the cowl assembly to the rear portion, where the rear shroud positioned above a rear portion of the cab.

In some embodiments, the method further includes coupling a frame member to a roof of the cab, with the frame member extending upwards and at least partially above the rear portion of the cab. The method further includes coupling the rear shroud to the frame member.

In some embodiments, the method further includes coupling a tarp cover assembly to the chassis at a front end of the roll-off body assembly, where the tarp cover assembly includes a tarp partially positioned within a tarp cover body, a support column connected to the tarp cover body and to the chassis, and a tarp cover actuator coupled to the chassis and configured to extend the tarp over the object positioned on the roll-off body. In some embodiments, the method further includes coupling at least part of a cowl assembly to the tarp cover assembly of the tarp cover assembly. In some embodiments, the method further includes coupling a rear shroud of a cowl assembly to the support column of the tarp cover assembly, with the rear shroud defining a storage compartment below the rear shroud and between the cab and the roll-off body assembly. The cowl assembly further includes a front shroud coupled to and positioned above the cab.

### BRIEF DESCRIPTION OF THE DRAWINGS

FIG. 1 is a left side view of an electric vehicle, according to an exemplary embodiment.

FIG. 2 is a perspective view of a chassis of the vehicle of FIG. 1.

FIG. 3 is a side view of an electric roll-off vehicle including a roll-off body in a first position, according to an exemplary embodiment.

FIG. 4 is a side view of the electric roll-off vehicle including the roll-off body in a second position, according to an exemplary embodiment.

FIG. 5 is a side view of an electric roll-off vehicle including a tarp cover assembly, according to an exemplary embodiment.

FIG. 6 is a side view of the electric roll-off vehicle including the tarp cover assembly, according to another exemplary embodiment.

FIG. 7 is a side view of an electric roll-off vehicle including a cowl assembly, according to an exemplary embodiment.

FIG. 8 is a side view of the electric roll-off vehicle including the cowl assembly, according to another exemplary embodiment.

FIG. 9 is a left side view of a vehicle including a cowl assembly configured for use with a roll-off body, according to an exemplary embodiment.

FIG. 10 is a flowchart of a method of assembling an electric roll-off vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the Figures, various embodiments of electric vehicles (e.g., electric roll-off vehicles) including a roll-off body assembly are provided. The roll-off body assembly includes a body actuator to raise and lower a roll-off body for loading and then carrying an object on the roll-off body. For example, the electric roll-off vehicle may be used as a refuse vehicle, where a refuse container is loaded onto the roll-off body for transporting the refuse container to a transfer station for disposing of refuse. Other objects may be loaded onto the roll-off body and similarly transported by the electric roll-off vehicle. The electric roll-off vehicle is structured to accommodate (e.g., maintain) the vehicle's electric components (and/or any electric to hydraulic components) without requiring a separate body, module, or assembly on a rear end of the chassis (in a body area of the vehicle) for mounting of said electric (and/or electric to hydraulic) components. Furthermore, the electronic equipment is arranged along the vehicle in an efficient manner that eliminates the need for additional space and/or mounting arrangements along the chassis.

According to an exemplary embodiment, an electric roll-off vehicle includes a chassis extending a longitudinal length of the electric roll-off vehicle and a cab coupled to a front end of the chassis. The electric roll-off vehicle further includes an electric energy storage device coupled to the chassis and an electric drive motor coupled to the chassis and electrically connected to the electric energy storage device for driving the electric roll-off vehicle. The electric roll-off vehicle further includes a roll-off body assembly coupled to the chassis and positioned behind the cab. The roll-off body assembly includes a roll-off body extending at least partially along the longitudinal length of the electric roll-off vehicle, a body actuator configured to move a front end of the roll-off body, and a container lift assembly comprising a cable and a lift motor, where the container lift assembly is configured to pull an object onto the roll-off body.

### Overall Vehicle

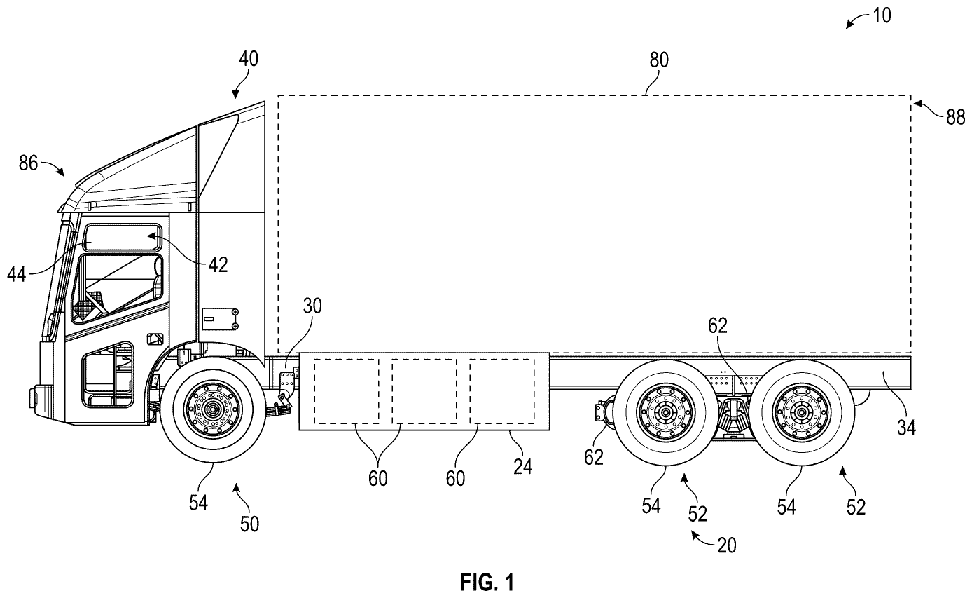

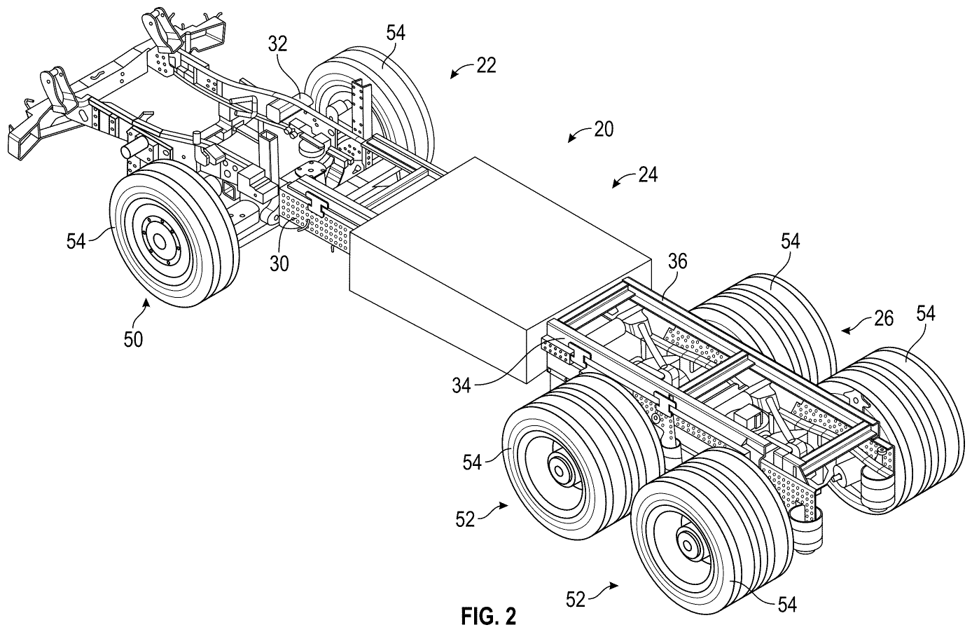

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10 (e.g., within or adjacent to the front section 22 and/or the rear section 26). The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 54 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the axle front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, such as a roll-off refuse vehicle as will be further described herein, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. In some embodiments, the reconfigurable vehicle cab 40 and chassis 20 may have a similar structure as described in U.S. application Ser. No. 19/004,153, filed Dec. 27, 2024, the entire contents of which are hereby incorporated by reference herein.

Although the application kit 80 is described as a separate assembly from the remainder of the vehicle 10 (e.g., from the chassis 20, from the cab 40, etc.) and in the context of a reconfigurable vehicle, it should be understood that in other embodiments the application kit 80 is a dedicated body, implement, etc. that is configured to be fixedly mounted to the vehicle 10 (e.g., to different parts of the vehicle 10, or forming portions of the vehicle 10).

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### Electric Roll-off Vehicle

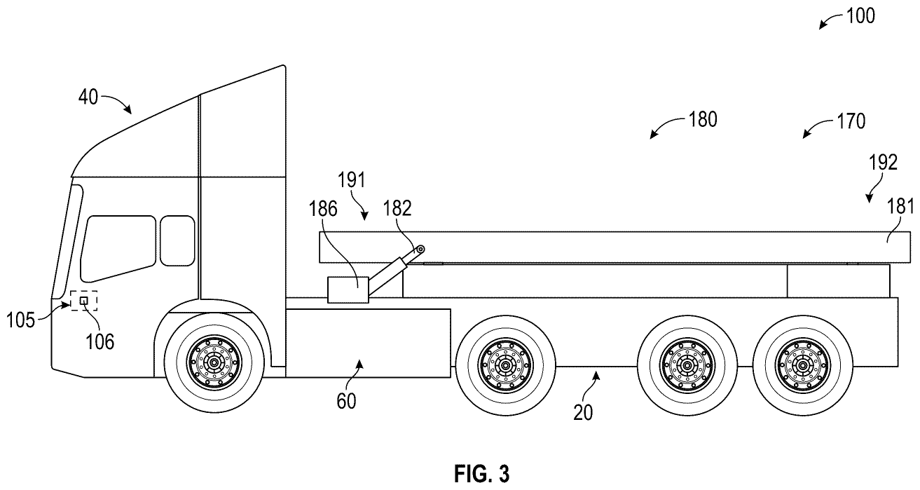

Referring to FIG. 3, a vehicle configured as an electric roll-off vehicle 100 that is propelled by an electric powertrain system is shown, according to an embodiment. The electric roll-off vehicle 100 includes a chassis 20 extending a longitudinal length of the vehicle and a cab 40 coupled to a front end of the chassis 20.

Referring to FIGS. 1 through 4, the electric roll-off vehicle 100 further includes one or more electric energy storage devices coupled to the chassis and one or more prime movers coupled to the chassis and electrically connected to the electric energy storage device for driving the electric roll-off vehicle. The one or more electrical energy storage devices (e.g., batteries, capacitors, etc.) are shown as batteries 60. In some embodiments, the batteries 60 are positioned within the middle section 24 of the chassis 20 as described with reference to FIGS. 1 and 2. The one or more prime movers and/or electromagnetic devices (e.g., motor/generators) are shown as drive motors 62. The drive motors 62 are electrically coupled to the batteries 60, where the drive motors 62 are configured to receive electrical energy from the batteries 60 and provide rotational mechanical energy to the wheel and tire assemblies 54 to propel the vehicle 10. The electric roll-off vehicle 100 further includes the application kit 80 (see FIG. 1) configured as a roll-off body assembly 180. In some embodiments, the electric roll-off vehicle 100 further includes a cowl assembly 120.

### A. Roll-off Body Assembly

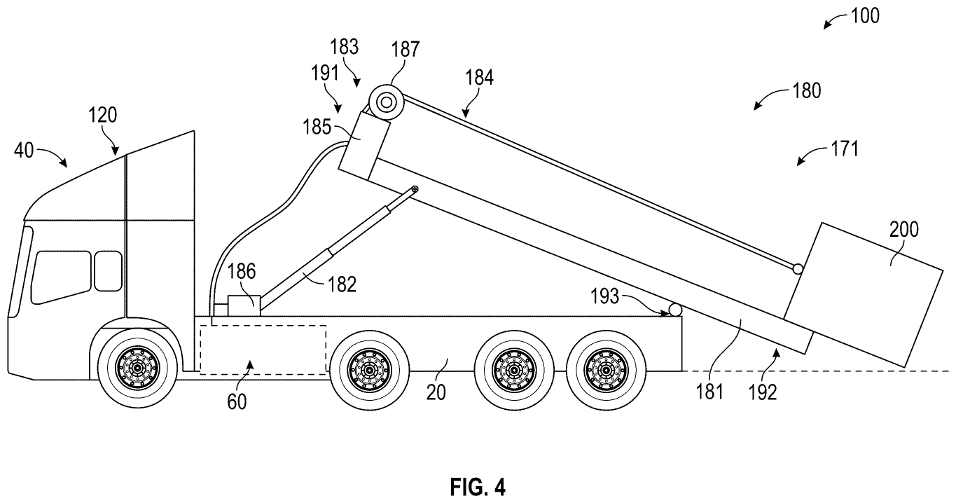

Referring to FIGS. 3 and 4, the electric roll-off vehicle 100 includes the roll-off body assembly 180. The roll-off body assembly 180 is coupled to the chassis 20. The roll-off body assembly 180 includes a roll-off body 181 extending a longitudinal length of the electric roll-off vehicle 100. For example, the roll-off body 181 may be a flat platform for supporting an object 200, which may include a commercial refuse container (e.g., a 10-yard container, a 20-yard container, a 30-yard container, a 40-yard container, or larger). The roll-off body assembly 180 further includes one or more body actuators, shown as body actuator 182, configured to raise a front end 191 of the roll-off body 181 and to pivot the roll-off body 181 relative to the chassis between a first, transit position, in which the roll-off body 181 extends along the longitudinal direction (see FIG. 3) and a second, bin collection position, in which the roll-off body 181 is angled with respect to the chassis (see FIG. 4). The roll-off body 181 may include a rear end 192 configured to rest on a ground surface for the object 200 to be slid onto the roll-off body 181 when the body actuator 182 raises the front end 191 of the roll-off body 181 (e.g., in the second position).

For example, the rear end 192 of the roll-off body 181 may be lowered (e.g., toward the ground surface) when the body actuator 182 raises the front end 191 of the roll-off body 181. The roll-off body assembly 180 further includes a container lift assembly, shown as winch assembly 183, including a cable 184 and a lift motor, shown as winch motor 185. The winch assembly 183 is configured to pull the object 200 onto the roll-off body 181.

During a collection operation, the body actuator 182 raises the front end 191 of the roll-off body 181, moving the roll-off body 181 from the first position to the second position, and so that the rear end 192 of the roll-off body 181 engages or is positioned adjacent to the ground surface. After moving the roll-off body 181, the cable 184 is attached to the object 200, and the winch motor 185 is activated to pull the object 200 onto the roll-off body 181. After lifting the object 200 onto the roll-off body 181, the body actuator 182 moves the roll-off body 181 from the second position back to the first position, lowering the front end 191 of the roll-off body 181 into a substantially level position for stably supporting the object 200 on the roll-off body 181 during transit of the electric roll-off vehicle 100.

In other embodiments, the roll-off body 181 may include another form of container lift assembly, actuator, or system in place of, or in combination with, the winch assembly 183. For example, the roll-off body 181 may include a retractable/extendible lift arm including a hook or another container engaging member to facilitate loading of the object 200 onto the roll-off body 181.

Referring still to FIGS. 3 and 4, the roll-off body 181 is configured to support the object 200 when the object 200 is loaded onto the roll-off body 181. The roll-off body 181 extends at least partially along the longitudinal length of the electric roll-off vehicle 100 (e.g., extends down the frame rails behind the cab 40). The roll-off body 181 may be or include the flat platform (e.g., a flatbed). The roll-off body 181 may be supported by the chassis 20 of the electric roll-off vehicle 100, such as directly on the chassis 20 or on an intermediate support between the chassis 20 and the platform.

The roll-off body 181 may be coupled to the chassis 20, such as at a pivot point 193 disposed at a rear end of the chassis 20. In some embodiments, the roll-off body 181 may be a support rail for the object 200 to be loaded onto the electric roll-off vehicle 100 with the object 200 resting on the frame rails (e.g., the first frame rail and the second frame rail) and the support rail (e.g., on top surfaces of the rails). In some embodiments, the roll-off body 181 may be configured to correspond to a bottom of the object 200. For example, the roll-off body 181 may be the support rail configured to mate with a corresponding rail and/or track on the bottom of the object 200 for loading onto the roll-off body 181.

In some embodiments, the roll-off body assembly 180 is coupled to the chassis 20. The roll-off body assembly 180 may be coupled to the chassis 20 at multiple points. The roll-off body assembly 180 may be coupled to the chassis 20 near the front end 191 of the roll-off body 181, where the body actuator 182 is coupled to both the chassis 20 and the roll-off body 181 for lifting the roll-off body 181 (e.g., raising the roll-off body 181 to load and/or unload the object 200). The roll-off body assembly 180 may also be connected to (e.g., pivotally coupled to) the chassis 20 at the pivot point 193 near the rear end 192 of the roll-off body assembly 180. The pivot point 193 is configured to anchor the roll-off body assembly 180 to the chassis 20 while the front end 191 of the roll-off body 181 is raised and/or lowered by the body actuator 182. For example, the pivot point 193 defines where the roll-off body 181 is configured for the rear end 192 of the roll-off body assembly 180 to be lowered when the front end 191 is raised by the body actuator 182. The pivot point 193 may define the ends of the roll-off body 181. For example, the front end 191 of the roll-off body 181 may be defined as a portion of the roll-off body 181 between the pivot point 193 and the cab 40 of the electric roll-off vehicle 100, while the rear end 192 of the roll-off body 181 may be defined as a portion of the roll-off body 181 between the pivot point 193 and a rear end of the electric roll-off vehicle 100 (e.g., where the rear end of the electric roll-off vehicle 100 is the end opposite the front end). In some embodiments, the pivot point 193 is formed by a pivot assembly including a shaft and a mount that rotatably couples the shaft to the chassis 20.

In some embodiments, the body actuator 182 is coupled to the chassis 20. For example, the body actuator 182 may be coupled to one of the frame rails. In some embodiments, the body actuator 182 is coupled to a side of one of the frame rails. In some embodiments, the body actuator 182 is coupled to a top surface of one of the frame rails. In some embodiments, the roll-off body assembly 180 further includes a secondary frame rail. The secondary frame rail may be connected to and positioned above one of the frame rails. The body actuator 182 may couple to the secondary frame rail (e.g., to a side of the secondary frame rail). Other configurations for mounting the body actuator 182 to the chassis 20 may be used for the body actuator 182 to raise and/or lower the roll-off body assembly 180.

In some embodiments, the body actuator 182 includes a hydraulic actuator powered by an electric motor. In such embodiments, the body actuator 182 is electrically coupled to the batteries 60 of the electric roll-off vehicle 100. The body actuator 182 includes an actuator motor 186 (e.g., the electric motor), electrically coupled to the batteries 60, for operating the body actuator 182. Such an arrangement can improve responsiveness and controllability of the actuator without requiring complex valving or hydraulic manifolds on the vehicle 100.

In some embodiments, the roll-off body assembly 180 (e.g., a container lift actuator) includes the winch assembly 183 including a winch body 187, the cable 184, and the winch motor 185. The winch body 187 is configured to hold the cable 184 (e.g., the cable 184 may be wrapped around the winch body 187 like a spool). The winch body 187 may be coupled to the chassis 20 of the electric roll-off vehicle 100. The cable 184 is attached to the winch body 187 at an anchoring end of the cable 184. An attachment end of the cable 184 may be attached to the object 200. The winch motor 185 is coupled to the winch body 187 for extending or retracting the cable 184 to pull the object 200 onto or off of the roll-off body 181. The winch motor 185 is electrically coupled to the batteries 60 of the electric roll-off vehicle 100. A container lift assembly disconnect (e.g., a winch disconnect) may be included between the winch motor 185 and the batteries 60 for selectively decoupling the winch assembly 183 from the electric roll-off vehicle 100 when the winch assembly 183 is not in use (e.g., for pulling the object). In some embodiments, the disconnect may be positioned between all electric actuators for the roll-off body assembly 180 and the batteries. In some embodiments, the hydraulic pumps, electric motors, power converter(s), and/or the disconnect may form part of an electric power take off (EPTO) system, as will be further described. Other configurations of the winch assembly 183 may be used.

In some embodiments, and as described above, the roll-off body assembly 180 is configured in a first position 170 (e.g., a level position, a transit position), where the roll-off body 181 is positioned substantially parallel to the chassis 20 of the electric roll-off vehicle 100. In the first position 170, the roll-off body 181 may be positioned substantially parallel to the ground. In the first position 170, the body actuator 182 is in a retracted position. In some embodiments, the object 200 is supported on the roll-off body 181 when the roll-off body assembly 180 is in the first position 170 for transporting the object 200 using the electric roll-off vehicle 100.

In some embodiments, the roll-off body assembly 180 is configured in a second position 171 (e.g., a roll-off position, a loading position, an angled position), where the roll-off body 181 is positioned angled to the chassis 20 of the electric roll-off vehicle 100. In the second position 171, the roll-off body 181 may be positioned angled to the ground. In the second position 171, the body actuator 182 is in an extended position. In some embodiments, the object 200 is unloaded and/or loaded (e.g., rolled-off/on) the roll-off body 181 when the roll-off body assembly 180 is in the second position 171. In some embodiments, the electric roll-off vehicle 100 used the body actuator 182 to move the roll-off body assembly 180 from the first position 170 to the second position 171. The body actuator 182 extends to raise the front end 191 of the roll-off body 181 and lower the rear end 192 of the roll-off body 181.

In some embodiments, the electric roll-off vehicle 100 includes the roll-off body assembly 180 configured in the first position 170, without the object 200, while the electric roll-off vehicle 100 is in transit from a first location (e.g., a parking area, a vehicle station). When the electric roll-off vehicle 100 arrives at a second location (e.g., at the object) to load the object 200 onto the electric roll-off vehicle 100, the body actuator 182 extends to move the roll-off body assembly 180 into the second position 171. The body actuator 182 raises the front end 191 of the roll-off body 181 and lowers the rear end 192 of the roll-off body 181 near the object 200 for loading the object 200 onto the roll-off body 181. The cable 184 of the winch assembly 183 is extended (e.g., by an operator) and attached to the object 200. The cable 184 may be extended and attached before the body actuator 182 raises the roll-off body 181. The winch motor 185 pulls the object 200 onto the roll-off body 181 by retracting the cable 184. The body actuator 182 retracts to lower the front end 191 of the roll-off body 181 and raise the rear end 192 of the roll-off body 181. The body actuator 182 may retract once the object 200 is loaded onto the roll-off body 181 using the winch assembly 183. The body actuator 182 may retract simultaneously to the object 200 being loaded onto the roll-off body 181 (e.g., retracting the body actuator 182 may help the winch motor 185 load the object 200). The body actuator 182 retracting configures the roll-off body assembly 180 back into the first position 170, with the object 200 loaded onto the roll-off body 181. The electric roll-off vehicle 100 may transport the object 200 to a third location with the roll-off body assembly 180 in the first position 170.

In some embodiments, the electric roll-off vehicle 100 may unload the object 200 off of the roll-off body 181 at an unloading location (e.g., the second location, the third location). The roll-off body assembly 180 is configured in the first position 170, with the object 200 loaded onto the roll-off body 181, until the electric roll-off vehicle 100 arrives at the second location. At the second location, the body actuator 182 moves the roll-off body assembly 180 (e.g., the platform) into the second position 171 for unloading the object 200. The cable 184 may be attached to the object 200, and the winch motor 185 may extend the cable 184 (e.g., give slack) for controlling motion of the object 200 during unloading. In the second position, the gravitational force acting on the object 200 may cause the object 200 to roll (e.g., slide) off the roll-off body 181and onto the ground surface. Once the object 200 is unloaded, the body actuator 182 retracts to return the roll-off body assembly 180 to the first position 170 for the electric roll-off vehicle 100 to drive to another location.

In some embodiments, the object 200 is a refuse container. For example, the electric roll-off vehicle 100 may be used to collect the refuse container when the refuse container is full of refuse for discarding the refuse. The electric roll-off vehicle 100 may drive from the first location (e.g., parking spot, charging station) to the second location (e.g., a worksite, office building), where the refuse container is positioned to be filled with refuse. The electric roll-off vehicle 100 may then drive to a third location (e.g., a central refuse collection area, a transfer station, a landfill) to deposit the refuse collected in the refuse container. The electric roll-off vehicle 100 may then drive back to the second location to return the refuse container for refuse collection. The electric roll-off vehicle 100 promotes environmentally beneficial refuse collection practices by enabling the use of renewable energy sources (e.g., wind, solar, etc.) in the collection of large refuse containers.

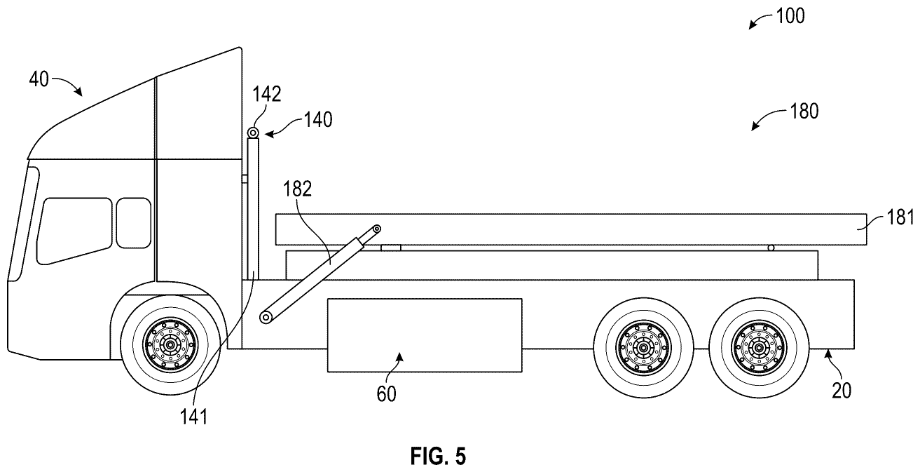

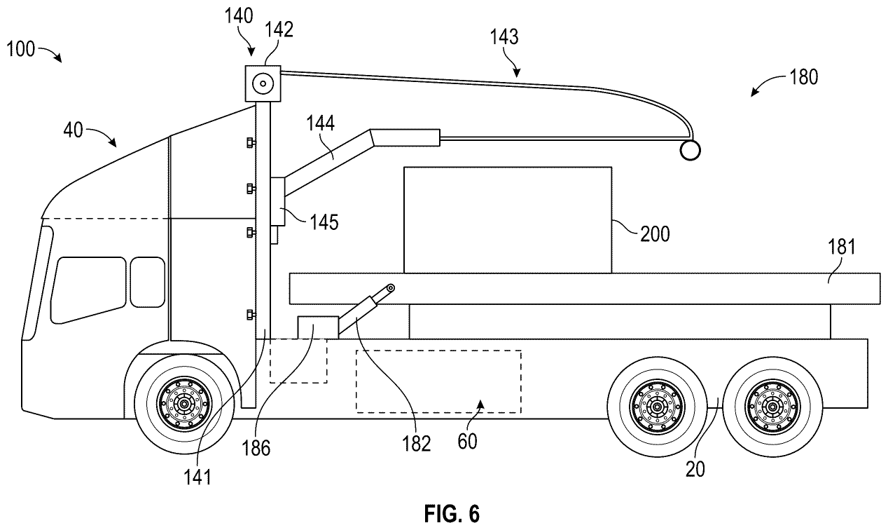

Referring to FIGS. 5 and 6, the roll-off body assembly 180 of the electric roll-off vehicle 100 further includes a tarp cover assembly 140. The tarp cover assembly 140 is coupled to the chassis 20 of the electric roll-off vehicle 100. In some embodiments, the tarp cover assembly 140 includes a frame, further including one or more support columns, shown as support column 141. The frame of the tarp cover assembly 140 is coupled to the chassis 20. The tarp cover assembly 140 further includes a tarp cover body 142, configured to store a tarp 143 for covering the object 200 loaded onto the roll-off body 181 (e.g., the tarp 143 may be wound around the tarp cover body 142 like a spool). The tarp cover body 142 is positioned at a first end of the support column 141. The tarp cover body 142 may include a housing to protect (e.g., from rain, snow, etc.) the tarp 143 when stored using the tarp cover body 142.

The tarp cover assembly 140 further includes one or more tarp cover actuators, shown as tarp cover actuator 144, configured to extend the tarp 143 from the tarp cover body 142 over the object 200 loaded onto the roll-off body 181 (e.g., extend the tarp 143 toward the rear end of the electric roll-off vehicle 100). A first end of the tarp cover actuator 144 is coupled to the tarp 143. A second end of the tarp cover actuator 144 is coupled to the chassis 20 of the electric roll-off vehicle 100. For example, the tarp cover actuator 144 may be coupled to one of the frame rails (e.g., to a top surface of one of the frame rails, a side surface of one of the frame rails, etc.). In some embodiments, a second tarp cover actuator may be configured similarly to the tarp cover actuator 144 on an opposite side of the roll-off body assembly 180.

The tarp cover assembly 140 further includes a tarp cover motor 145 configured to operate the tarp cover actuator 144 for covering the object 200 loaded onto the roll-off body 181. The tarp cover motor 145 may be an electric motor. In some embodiments, the tarp cover assembly 140 may be electrically coupled to the batteries 60 of the electric roll-off vehicle 100. For example, the tarp cover motor 145 may be electrically coupled with the batteries 60 for operating the tarp cover assembly 140. The tarp cover assembly 140 may be configured to be operated by an operator of the electric roll-off vehicle 100 (e.g., via a controller based on inputs from a user interface within the cab 40 or alongside the vehicle

### 100).

In some embodiments, the tarp cover assembly 140 is configured where the support column 141 positions the tarp cover body 142 at a height above the object 200 loaded onto the roll-off body 181. For example, the tarp cover body 142 may be positioned at a height corresponding to a rear shroud 122 (e.g., a guard, a cowl) behind a cab 40 of the vehicle 100 that is used to store one or more system components of the vehicle 100 (e.g., the electric motors, the hydraulic pump, the power converter(s), the disconnect, etc.). In some embodiments, the tarp cover body 142 is positioned at a height below the rear shroud 122. In some embodiments, the tarp cover body 142 is positioned at a height above the rear shroud 122. The tarp cover body 142 may be positioned at a height above the cab 40 of the electric roll-off vehicle 100. For example, the tarp cover assembly 140 may extend above the cab 40.

Referring to FIGS. 1 through 6, the roll-off body assembly 180 and/or components thereof (e.g., the winch assembly 183, the tarp cover assembly 140, the body actuator 182, etc.) are communicably coupled to a control system 105 of the electric roll-off vehicle 100. The control system 105 may include a controller 106 in communication with a control panel (e.g., user interface, user controller, inputs, etc.). The control panel may include one or more user interfaces (e.g., buttons, levers, joysticks, knobs, LCD displays, touch displays, etc.) that, when interacted with (e.g., pressed, touched, engaged, etc.) by an operator of the electric roll-off vehicle 100, transmits a signal to the controller 106 to command one or more components of the roll-off body assembly 180 (e.g., the winch motor 185, the body actuator 182, the actuator motor 186) to perform an action. Each panel button included in the control panel may be associated with a different action and/or operation of the one or more components of the roll-off body assembly 180. In other embodiments, multiple actions may be performed using a single user interface component (e.g., a joystick, etc.).

The controller 106 may include a processing circuit having a processor and memory. The processing circuit can be communicably connected to a communications interface such that the processing circuit and the various components thereof can send and receive data via the communications interface. The processor can be implemented as a general purpose processor, an application specific integrated circuit (“ASIC”), one or more field programmable gate arrays (“FPGAs”), a group of processing components, or other suitable electronic processing components. The memory (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory can be or include volatile memory or non-volatile memory. The memory can include database components, object code components, script components, or any other type of information structure for supporting the various activities and information structures described in the present application. According to some embodiments, the memory is communicably connected to the processor via the processing circuit and includes computer code for executing (e.g., by the processing circuit and/or the processor) one or more processes described herein.

### B. Cowl Assembly

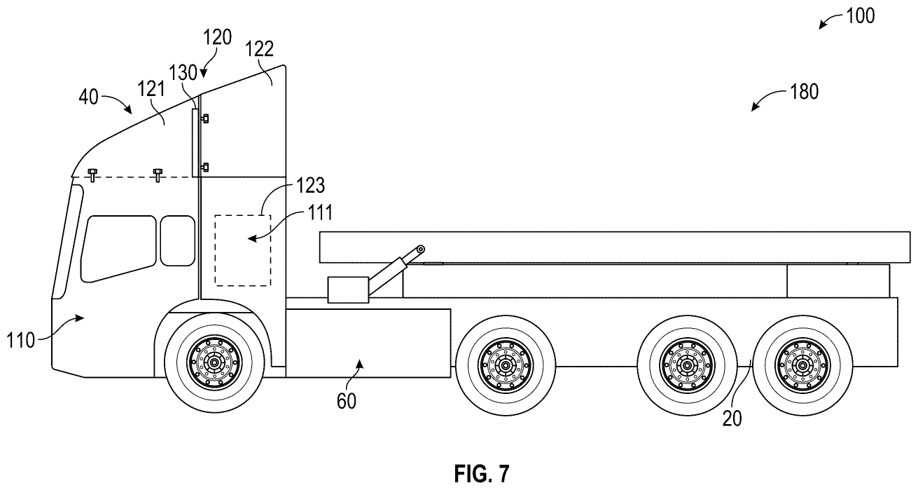

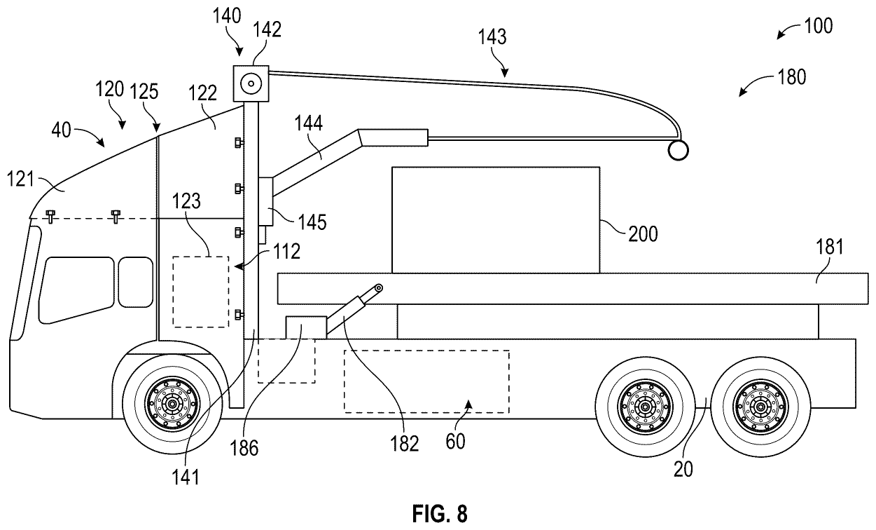

Referring to FIGS. 7 and 8, the electric roll-off vehicle 100 also includes a cowl assembly 120 that is configured to house various components of the vehicle 100 and to improve aerodynamic efficiency (e.g., reduce drag) during transit operations. The cowl assembly 120 may be the same as or similar to the cowl assembly configuration described in U.S. application Ser. No. 18/110,976, filed Feb. 17, 2023, the entire contents of which are hereby incorporated by reference herein.

In some embodiments, the cowl assembly 120 is coupled to and supported by the cab 40 (e.g., by a front section 22 of the chassis as shown in FIG. 2). The cowl assembly 120 includes a front shroud 121 and a rear shroud 122. In some embodiments, the front shroud 121 is coupled to and positioned above a front portion 110 of the cab 40, while the rear shroud 122 is coupled to and positioned above a rear portion 111 of the cab 40. In some embodiments, the front shroud 121 coupled to and positioned above the cab 40, while the rear shroud 122 defines a storage compartment 112 below the rear shroud 122 and between the cab 40 and the roll-off body assembly 180. The rear shroud 122 may be coupled to the tarp cover assembly 140 of the roll-off body assembly 180 when defining the storage compartment 112.

As shown in FIG. 7, the cab 40 includes a first portion (e.g., an operator portion), shown as front portion 110, and a second portion (e.g., a storage portion), shown as rear portion 111, each coupled to the chassis 20. The front portion 110 defines the cab interior 42 and is configured to contain one or more operators. The rear portion 111 is positioned between the front portion 110 and the roll-off body assembly 180. In some embodiments, the rear portion 111 defines one or more storage spaces that contain components of the electric roll-off vehicle 10 (e.g., pumps, batteries, plumbing, etc.) and/or provide storage for items placed by an operator (e.g., clothing, equipment, etc.). The rear portion 111 may include one or more doors that facilitate accessing the storage spaces (e.g., a transition door assembly). In some embodiments, the front portion 110 and the rear portion 111 are fixedly coupled to the chassis 20 (e.g., the front portion 110 and the rear portion 111 remain stationary when the roll-off body 181 is raised). In some embodiments, the storage portion 110 may be a separate compartment and/or portion from the front portion 110, where the storage portion 110 is coupled to the cab 40 (e.g., to a rear wall and/or support element of the cab 40).

The electric roll-off vehicle 100 includes one or more covers, guards, cowls, or flow control members, shown as cowl assembly 120. The roll-off vehicle includes the cowl assembly 120 including the front shroud 121 (e.g., a front cowl portion). The front shroud 121 is positioned directly above the front portion 110 of the cab 40. The front shroud 121 is coupled to the front portion 110. For example, the front shroud 121 may be coupled to a roof of the cab 40. The front shroud 121 may couple to the front portion 110 using fasteners (e.g., bolts). In the embodiment of FIG. 7, the front shroud 121 defines a front-facing surface that slopes gradually.

The cowl assembly 120 further includes the rear shroud 122 (e.g., a rear cowl). The rear shroud 122 is positioned directly above the rear portion 111 of the cab 40. The rear shroud 122 is coupled to the cab 40. For example, the rear shroud 122 may couple to the rear portion 111 using fasteners (e.g., the rear shroud 122 may be bolted to the cab 40). The rear shroud 122 is positioned behind the front shroud 121. In some embodiments, the rear shroud 122 is also connected to the front shroud 121.

In some embodiments, the cab 40 includes a frame member, shown as shroud frame member 130, configured to couple the rear shroud 122 to the cab 40, such as to a rear wall of the cab 40 (e.g., a B-pillar of the cab 40, etc.) and/or another structural member adjacent to a rear wall of the cab 40. The shroud frame member 130 may extend above (e.g., upwards from) the cab 40. The shroud frame member 130 may extend from the roof of the cab 40. The shroud frame member 130 may extend above the rear portion 111 of the cab 40. The rear shroud 122 may be coupled to the shroud frame member 130 using fasteners and/or by at least one welded connection. In some embodiments, the shroud frame member 130 may be shaped to correspond to an outer perimeter of the rear shroud 122 (e.g., the shroud frame member 130 may be shaped corresponding an outer edge defining the rear shroud 122). In some embodiments, the shroud frame member 130 may be shaped to correspond to an outer perimeter of the front shroud 121 (e.g., the shroud frame member 130 may be shaped corresponding an outer edge defining the rear shroud 122).

In some embodiments, the front shroud 121 is also coupled to the shroud frame member 130. For example, the front shroud 121 may be coupled to an opposite side (e.g., a front side) of the shroud frame member 130 as the rear shroud 122 (e.g., coupled to a rear side of the shroud frame member 130). In some embodiments, the shroud frame member 130 may extend above the front portion 110 of the cab 40. The shroud frame member 130 may extend between (e.g., straddle) the front portion 110 and the rear portion 111 of the cab 40. The shroud frame member 130 may be shaped to correspond to the outer perimeters of the front shroud 121 and the rear shroud 122, where the front shroud 121 and the rear shroud 122 align. The shroud frame member 130 may extend above both the front portion 110 and the rear portion 111 of the cab 40. In some embodiments, the shroud frame member 130 may extend from a rear wall 46 of the cab 40 to couple the rear shroud 122.

In some embodiments, the front-facing surface of the front shroud 121 of the electric roll-off vehicle 100 slopes gradually from the front surface of the cab 40 to a top surface of the rear shroud 122. The top surface of the rear shroud 122 may extend within a substantially horizontal plane (e.g., within a plane that is substantially parallel to a ground surface that the roll-off vehicle is traversing on) from the front shroud 121 toward the roll-off body assembly 180. This gradual transition may reduce the drag on the electric roll-off vehicle 100 when the electric roll-off vehicle 100 is in transit. Reducing the drag on the electric roll-off vehicle 100 can increase operating range of the electric roll-off vehicle 100.

In some embodiments, the cowl assembly, or portions thereof, may be supported independent from the cab 40. For example, and referring to FIG. 8, a cowl assembly 120 is shown that is supported by a tarp cover assembly 140 of the electric roll-off vehicle 100. The cowl assembly 120 includes a front shroud 121 coupled to the cab 40 and positioned above the cab 40; and the rear shroud 122 coupled to the tarp cover assembly 140 of the roll-off body assembly 180 and extending forward from the tarp cover assembly 140 toward the front shroud 121. A space, volume, or compartment, shown as storage compartment 112, is defined between the roll-off body assembly 180, the cab 40, the rear shroud 122, and the chassis 20. Specifically, the storage compartment 112 is positioned below the rear shroud 122, above the chassis 20, forward of the roll-off body assembly 180, and behind the cab 40. In some embodiments, the storage compartment 112 occupies the same space as the rear portion 111 of the cab 40 shown in FIG. 7.

In some embodiments, the rear shroud 122 is coupled to the tarp cover assembly 140, such as to an upper portion of the tarp cover assembly 140. For example, the rear shroud 122 may be coupled to one of the support columns of the tarp cover assembly 140. In the embodiment of FIG. 8, the rear shroud 122 is coupled to the support column 141 along an upper end (e.g., a first end, a distal end, etc.) of the support column 141. In some embodiments, the rear shroud 122 is additionally, or alternatively, coupled to the tarp cover body 142 of the tarp cover assembly 140 that is configured to support the tarp 143 when retracted from the object 200 (e.g., the tarp cover assembly 140 that is coupled to the upper end of the support column 141).

In some embodiments, the tarp cover assembly 140 and/or the support column 141 includes one or more coupling members that are configured to enable fastening of the rear shroud 122 to the tarp cover assembly 140. For example, the tarp cover assembly 140 may include another support column 141 extending from the support column 141 or another component thereof to facilitate mounting of the rear shroud 122 to the tarp cover assembly 140. In some embodiments, the coupling member includes a crossbar member of the tarp cover assembly 140 (e.g., a member extending between the support columns and configured for coupling the rear shroud 122). In some embodiments, the rear shroud 122 is coupled to the tarp cover assembly 140 using fasteners (e.g., bolts, screws, rivets, or another mechanical fastener). In other embodiments, the rear shroud 122 (e.g., a support member of the rear shroud 122, etc.) is welded or otherwise permanently affixed to the tarp cover assembly 140.

In some embodiments, the electric roll-off vehicle 100 includes a storage assembly 123, positioned between the cab 40 and the roll-off body assembly 180. More specifically, the storage assembly 123 is positioned (i) between the rear wall 46 of the cab 40 and the tarp cover assembly 140 of the roll-off body assembly 180, (ii) rearward of the cab door 44 of the cab 40, (iii) beneath the rear shroud 122 of the cowl assembly 120, and (iv) forward of the roll-off body assembly 180. In some embodiments, the storage assembly 123 is coupled to the tarp cover assembly 140. For example, the storage assembly 123 may be coupled to one or more of the support columns of the tarp cover assembly 140. For example, the storage assembly 123 may be coupled to the support column 141, such as to a lower end (e.g., a second end, a proximal end, etc.) of the support column 141 that is below the upper end and that is adjacent to the chassis. In some embodiments, the storage assembly 123 may include a transition door assembly for accessing an interior space (e.g., the storage compartment 112) of the storage assembly 123.

In some embodiments, the storage assembly 123 is coupled to the tarp cover assembly 140 using fasteners (e.g., bolted onto the support column 141 of the tarp cover assembly 140). In some embodiments, the storage assembly 123 may be coupled to the tarp cover assembly 140 similarly to how the rear shroud 122 may be coupled to the tarp cover assembly 140. In some embodiments, the storage assembly 123 is coupled to the rear shroud 122. In some embodiments, the storage assembly 123 is also coupled to the chassis and/or a support member extending from the chassis (e.g., to the middle section 24 and/or the rear section 26 of the chassis as shown in FIG. 2), which can improve the strength and durability of the connection between the storage assembly 123 and the vehicle.

Among other benefits, decoupling a rear portion of the cowl assembly 120 from the cab 40 and/or the front section 22 of the chassis can reduce loading on the cab 40 and the weight carried by the forward axle. During operation, the electric roll-off vehicle 100 may experience various loadings that cause the roll-off body assembly 180 to move relative to the cab 40. By way of example, if the electric roll-off vehicle 100 drives over a bump or depression in a road surface, the roll-off body assembly 180 may rotate relative to the cab 40 about a longitudinal axis. Because the front shroud 121 is coupled to the cab 40 and the rear shroud 122 is coupled to the tarp cover assembly 140 of the roll-off body assembly 180, this relative movement of the cab 40 and the roll-off body assembly 180 causes a corresponding relative movement of the front shroud 121 and the rear shroud 122. A body gap 125 defined between the cab 40 and the tarp cover assembly 140 of the roll-off body assembly 180 may be sized to prevent or minimize contact between the front shroud 121 and the rear shroud 122 when such relative movement occurs.

In some embodiments, the cowl assembly 120 is configured to house electrical and/or hydraulic components of the electric roll-off vehicle 100. For example, the cowl assembly 120 may form part of an electric power take-off (EPTO) system 320 (e.g., an EPTO pod, an EPTO module) that is configured to provide an electric-to-hydraulic interface for working components onboard the electric roll-off vehicle 100. For example, the cowl assembly 120 may house and/or support the power converter(s) (e.g., inverter(s), DC-to-DC converter, etc.) that are configured to modulate or otherwise convert DC power from the batteries 60 for use with the electric motors powering the functionality of the roll-off body 181 (e.g., the body actuator 182, the container lift actuator, etc.). The cowl assembly 120 may also house and/or support a disconnect enabling electrical and/or hydraulic isolation of the various components of the EPTO system, such as through a single connection bus, which can eliminate the need to independently connect each component to the batteries 60 and/or the working components onboard the electric roll-off vehicle 100.

In some embodiments, the EPTO system 320 includes a reservoir, a pump, a motor, and an inverter. The EPTO system 320 is configured to operate and/or control an actuator. The actuator may be the body actuator 182. The reservoir provides a supply of low-pressure (e.g., atmospheric) fluid (e.g., hydraulic fluid). The pump is fluidly coupled to the reservoir and draws low pressure fluid from of the reservoir and supplies the fluid at increased pressure to the actuator. The pump supplies pressurized (e.g., high pressure) fluid to the actuator in order to complete one or more functions, such as raising and/or lowering the body actuator 182. The EPTO system 320 is electrically coupled to the batteries 60. In other words, the EPTO system 320 is an electrical to hydraulic interface of the electric roll-off vehicle 100.

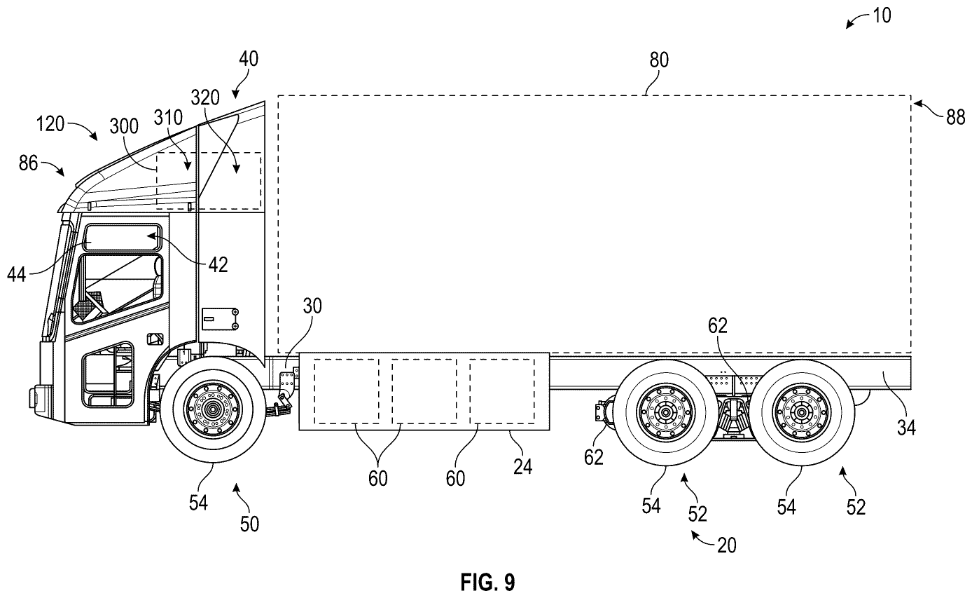

Referring to FIG. 9, the electric roll-off vehicle 100 also includes a cooling assembly 310 positioned within a radiator volume 300 defined by the cowl assembly 120. Specifically, the cooling assembly 310 is positioned between the roof of the cab 40 and the front shroud 121. The cooling assembly 310 is configured to cool components of the electric roll-off vehicle 100. Such an arrangement can reduce the overall footprint of the vehicle and can increase the usable space along the chassis 20 (e.g., for supporting actuators, etc.). In other embodiments, the position of the cooling assembly 310 may be different.

In some embodiments, the EPTO system 320 is positioned within the radiator volume 300 of the cowl assembly 120. The EPTO system 320 may be coupled to the cab 40 (as shown in FIG. 7) or to a body portion of the chassis 20 that is separate from the cab 40 (as shown in FIG. 8). In some embodiments, the EPTO system 320 may be coupled to the roof of the cab 40. In some embodiments, the EPTO system 320 may be coupled to the cab 40 and positioned within the radiator volume 300 of the cowl assembly 120 underneath the rear shroud 122. The EPTO system 320 may be positioned within the radiator volume 300 along with the cooling assembly 310.

In some embodiments, the EPTO system 320 is positioned within the storage compartment 112 and/or the storage assembly 123, beneath the rear shroud 122. For example, the EPTO system 320 may be positioned between the cab 40 and the roll-off body assembly 180. In some embodiments, the EPTO system 320 may be coupled to the roll-off body assembly 180. The EPTO system 320 may not be coupled to the cab 40 when the EPTO system 320 is coupled to the roll-off body assembly 180. The positioning of the EPTO system 320 and the coupling of the EPTO system 320 to the electric roll-off vehicle 100 may differ according to various embodiments of the electric roll-off vehicle 100, as disclosed herein.

### C. Method of Assembly

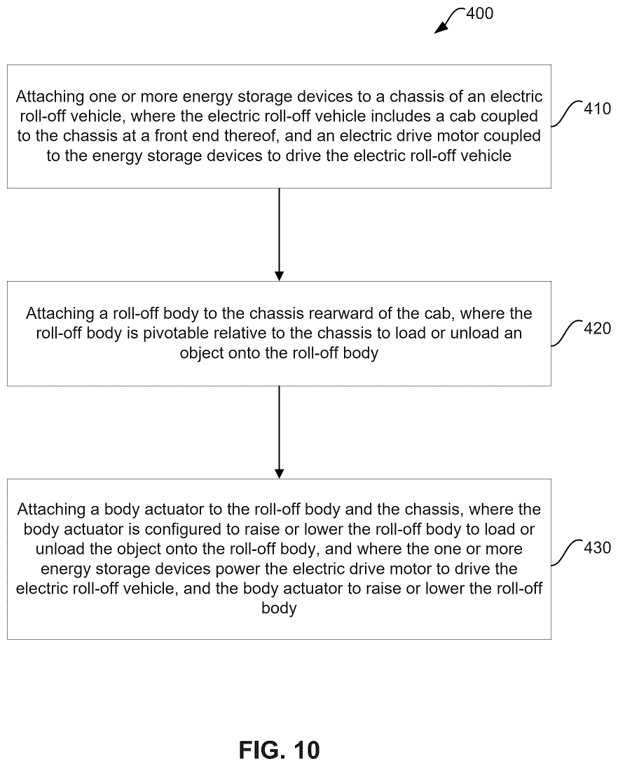

Referring to FIG. 10, a method 400 for assembling an electric roll-off vehicle is depicted. For example, the method 400 may be completed (e.g., carried out, implemented, etc.) to assemble an embodiment of the electric roll-off vehicle 10, as described herein. In some embodiments, the method 400 may include additional, fewer, and/or a different order of method steps.

The method 400 includes attaching (e.g., coupling, connecting, etc.) one or more energy storage devices to a chassis of the electric roll-off vehicle, where the electric roll-off vehicle includes a cab coupled to the chassis at a front end thereof, and an electric drive motor coupled to the energy storage devices (e.g., to drive the electric roll-off vehicle, etc.), at 410. For example, the chassis including the energy storage devices may be similar to an embodiment of the chassis 20 (e.g., including the batteries 60, etc.), as described herein. In some embodiments, the one or more energy storage devices may be positioned rearward of the cab of the electric roll-off vehicle.

The method 400 may include attaching (e.g., coupling, connecting, etc.) a roll-off body to the chassis rearward of the cab, where the roll-off body is pivotable relative to the chassis (e.g., to load or unload an object onto the roll-off body, etc.), at 420. For example, the roll-off body may be similar to an embodiment of the roll-off body 181, as described herein. In some embodiments, the method 400 may include attaching a winch assembly to the chassis and/or the roll-off body, where the winch assembly is configured to pull the object onto the roll-off body (e.g., and/or release the object from the roll-off body, etc.).

The method 400 may include attaching (e.g., coupling, connecting, etc.) a body actuator to the roll-off body and the chassis, where the body actuator is configured to raise or lower the roll-off body to load or unload the object onto the roll-off body, and where the one or more energy storage devices power the electric drive motor to drive the electric roll-off vehicle, and the body actuator to raise or lower the roll-off body, at 430. For example, the body actuator may be similar to an embodiment of the body actuator 182, as described herein. In some embodiments, electrically coupling the electric drive motor and/or operational components onboard the vehicle (e.g., the body actuator, the winch assembly, a tarp cover assembly, etc.) forms the all-electric roll-off vehicle, as described herein (e.g., where driving the vehicle and operating the components onboard are completed using electrical energy, etc.).

In some embodiments, the electric roll-off vehicle includes a cowl assembly (e.g., to house various components of the vehicle and/or to improve aerodynamic efficiency during transit, etc.). The cowl assembly may be positioned at least partially above the cab of the electric roll-off vehicle. For example, the method 400 may include coupling a cowl assembly to the cab of the electric roll-off vehicle. The cab may include a front portion configured as an operator portion and a rear portion configured as a storage portion. The cowl assembly may include multiple shrouds forming the cowl assembly. For example, the cowl assembly may be similar to an embodiment of the cowl assembly 120, as described herein. In some embodiments, for example, the method 400 may include attaching a front shroud of the cowl assembly to the front portion of the cab, wherein the front shroud portion is position above the front portion, and/or attaching a rear shroud of the cowl assembly to the rear portion, where the rear shroud is positioned above a rear portion of the cab. In some embodiments, the cab may be an embodiment of the cab 16, as described herein. In some embodiments, the method 400 may include attaching a frame member to a roof of the cab (e.g., which extends upwards and at least partially above the rear portion of the cab). The frame member may provide a mounting structure for the rear shroud (e.g., since the roll-off body may be too short to couple the rear shroud to, etc.). For example, the method 400 may include attaching the rear shroud to the frame member.

In some embodiments, the electric roll-off vehicle may include a tarp cover assembly (e.g., to extend and/or retract a tarp over an object positioned on the roll-off body, etc.). For example, the method 400 may include attaching a tarp cover assembly to the chassis at a front end of the roll-off body assembly. In some embodiments, the tarp cover assembly may include a tarp partially positioned within a tarp cover body. The tarp cover assembly may include a support column connected to the tarp cover body and to the chassis. The tarp cover assembly may include a tarp cover actuator coupled to the chassis and configured to extend the tarp over the object positioned on the roll-off body.

In some embodiments, the method 400 may include attaching at least part of a cowl assembly to the tarp cover assembly of the tarp cover assembly (e.g., as the tarp cover assembly may provide a support structure disposed rearward of the cab, which may mount the cowl assembly, such as the rear shroud, thereon, etc.). For example, the method 400 may include attaching a rear shroud of a cowl assembly to the support column of the tarp cover assembly, where the rear shroud defines a storage compartment below the rear shroud and between the cab and the roll-off body assembly. The front shroud of the cowl assembly may be coupled to and positioned above the cab (e.g., such as the front portion thereof, etc.).

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. An electric roll-off vehicle comprising:
a chassis extending a longitudinal length of the electric roll-off vehicle;
a cab coupled to a front end of the chassis;
an electric energy storage device coupled to the chassis;
an electric drive motor coupled to the chassis and electrically connected to the electric energy storage device for driving the electric roll-off vehicle; and
a roll-off body assembly coupled to the chassis and positioned behind the cab, the roll-off body assembly comprising:
a roll-off body extending at least partially along the longitudinal length of the electric roll-off vehicle;
a body actuator configured to move the roll-off body relative to the chassis, the body actuator powered by the electric energy storage device; and
a container lift assembly configured to pull an object onto the roll-off body.

2. The electric roll-off vehicle of claim 1, wherein the cab further comprises a front portion configured as an operator portion and a rear portion configured as a storage portion; and the electric roll-off vehicle further comprises a cowl assembly comprising:
a front shroud coupled to and positioned above the front portion of the cab; and
a rear shroud coupled to and positioned above a rear portion of the cab.

3. The electric roll-off vehicle of claim 2, wherein the rear portion of the cab comprises a frame member extending upwards from a roof of the rear portion, the frame member configured to couple to the rear shroud of the cowl assembly.

4. The electric roll-off vehicle of claim 1, further comprising a tarp cover assembly coupled to the chassis at a front end of the roll-off body assembly.

5. The electric roll-off vehicle of claim 4, wherein the tarp cover assembly comprises:
a tarp partially positioned within a tarp cover body;
a support column connected to the tarp cover body and to the chassis; and
a tarp cover actuator coupled to the chassis and configured to extend the tarp over the object positioned on the roll-off body.

6. The electric roll-off vehicle of claim 4, further comprising a cowl assembly positioned at least partially above the cab, wherein at least part of the cowl assembly is coupled to the tarp cover assembly.

7. The electric roll-off vehicle of claim 5, wherein the cab further comprises a front portion configured as an operator portion and a rear portion configured as a storage portion; and the electric roll-off vehicle further comprises a cowl assembly at least partially coupled to the tarp cover assembly.

8. The electric roll-off vehicle of claim 7, wherein the cowl assembly comprises:
a front shroud coupled to and positioned above the front portion of the cab; and
a rear shroud positioned above the rear portion of the cab, the rear shroud coupled to the tarp cover assembly.

9. The electric roll-off vehicle of claim 8, wherein the rear shroud is coupled to the support column of the tarp cover assembly.

10. An electric roll-off vehicle comprising:
a chassis extending a longitudinal length of the electric roll-off vehicle;
a cab coupled to a front end of the chassis;
an electric energy storage device coupled to the chassis;
an electric drive motor coupled to the chassis and electrically connected to the electric energy storage device for driving the electric roll-off vehicle;
a roll-off body assembly coupled to the chassis and positioned behind the cab, the roll-off body assembly comprising:
a roll-off body extending at least partially along the longitudinal length of the electric roll-off vehicle;
a body actuator configured to move a front end of the roll-off body;
a container lift assembly comprising a cable and a lift motor, wherein the container lift assembly is configured to pull an object onto the roll-off body;
a tarp cover assembly coupled to the chassis at a front end of the roll-off body assembly; and
a cowl assembly comprising:
a front shroud coupled to and positioned above the cab; and
a rear shroud coupled to the tarp cover assembly and defining a storage compartment below the rear shroud and between the cab and the roll-off body assembly.

11. The electric roll-off vehicle of claim 10, wherein the tarp cover assembly comprises:
a tarp partially positioned within a tarp cover body;
a support column connected to the tarp cover body and to the chassis; and
a tarp cover actuator coupled to the chassis and configured to extend the tarp over the object positioned on the roll-off body.

12. The electric roll-off vehicle of claim 11, wherein the rear shroud is coupled to the support column of the tarp cover assembly.

13. The electric roll-off vehicle of claim 11, wherein the electric energy storage device powers the electric drive motor to drive the electric roll-off vehicle, the body actuator to raise or lower the roll-off body, and the tarp cover actuator to extends or retract the tarp over the object.

14. A method of assembling an electric roll-off vehicle, the method comprising:
coupling one or more energy storage devices to a chassis of the electric roll-off vehicle, wherein the electric roll-off vehicle comprises:
a cab coupled to the chassis at a front end thereof; and
an electric drive motor coupled to the energy storage devices, the electric drive motor configured to drive the electric roll-off vehicle, wherein the one or more energy storage devices are positioned rearward of the cab of the electric roll-off vehicle;
coupling a roll-off body to the chassis rearward of the cab, the roll-off body pivotable relative to the chassis to load or unload an object onto the roll-off body; and
coupling a body actuator to the roll-off body and the chassis so that the body actuator is configured to raise or lower the roll-off body to load or unload the object onto the roll-off body and so that the body actuator is powered by the one or more energy storage devices.

15. The method of claim 14, further comprising coupling a cowl assembly to the cab of the electric roll-off vehicle, wherein the cab comprises a front portion configured as an operator portion and a rear portion configured as a storage portion.

16. The method of claim 15, wherein coupling the cowl assembly to the cab of the electric roll-off vehicle comprises:
coupling a front shroud of the cowl assembly to the front portion of the cab, wherein the front shroud portion is position above the front portion; and
coupling a rear shroud of the cowl assembly to the rear portion, wherein the rear shroud positioned above a rear portion of the cab.

17. The method of claim 16, further comprising:
coupling a frame member to a roof of the cab, the frame member extending upwards and at least partially above the rear portion of the cab; and
coupling the rear shroud to the frame member.

18. The method of claim 14, further comprising coupling a tarp cover assembly to the chassis at a front end of the roll-off body assembly, wherein the tarp cover assembly comprises:
a tarp partially positioned within a tarp cover body;
a support column connected to the tarp cover body and to the chassis; and
a tarp cover actuator coupled to the chassis and configured to extend the tarp over the object positioned on the roll-off body.

19. The method of claim 18, further comprising coupling at least part of a cowl assembly to the tarp cover assembly of the tarp cover assembly.

20. The method of claim 18, further comprising coupling a rear shroud of a cowl assembly to the support column of the tarp cover assembly, the rear shroud defining a storage compartment below the rear shroud and between the cab and the roll-off body assembly, wherein the cowl assembly further comprises a front shroud coupled to and positioned above the cab.
